(19) United States
(12) Patent Application Publication
(10) Pub. No.: US 2026/0213148 A1
(43) Pub. Date: Jul. 23, 2026

(54) Ion Guide Bandpass Filter with LINAC Electrodes

(71) Applicant: DH Technologies Development Pte. Ltd., Singapore (SG)

(72) Inventors: Mircea GUNA, Toronto (CA); Yang KANG, Richmond Hill (CA); William LOYD, Sugar Land, TX (US); Bradley B. SCHNEIDER, Bradford (CA); Andrei SONOC, Richmond Hill (CA)

(21) Appl. No.: 19/135,607

(22) PCT Filed: Dec. 5, 2023
(86) PCT No.: PCT/IB2023/062254

§ 371 Date: Jun. 4, 2025

Related U.S. Application Data
(60) Provisional application No. 63/430,141, filed on Dec. 5, 2022.

(51) Int. Cl. H01J 49/06; H01J 49/02

(52) U.S. Cl. CPC H01J 49/063; H01J 49/022

(57) ABSTRACT

In one aspect, a method for transmitting ions in a mass spectrometer includes using rods arranged in a multipole configuration and extending from proximity of an inlet of an ion guide to proximity of an outlet of the ion guide to generate an electromagnetic field for radially confining ions received via the inlet into a space between said rods, using auxiliary electrodes positioned between the rods to generate an electric field in a first region of the ion guide for reducing radial confinement of a first subset of the received ions in said first region to inhibit passage thereof to a downstream second region of the ion guide while allowing a second subset of the ions to reach the downstream second region, and axially accelerating said second subset of the ions in said downstream second region to expedite exit of said second subset of the ions from the ion guide.

### RELATED APPLICATIONS

This application claims priority to U.S. Provisional Application No. 63/430,141 filed on Dec. 5, 2022, the contents of which are incorporated herein in their entirety.

### TECHNICAL FIELD

The present disclosure relates to mass spectrometry and more particularly to methods and systems for use in acquiring MRM mass spectra of compounds.

### BACKGROUND

The present teachings are generally directed to systems and methods for mass spectrometry, and more particularly, to an ion guide that can be used in a mass spectrometer.

Mass spectrometry (MS) is an analytical technique for determining the structure of test chemical substances with both qualitative and quantitative applications. MS can be useful for identifying unknown compounds, determining the composition of atomic elements in a molecule, determining the structure of a compound by observing its fragmentation, and quantifying the amount of a particular chemical compound in a mixed sample. Mass spectrometers detect chemical entities as ions such that a conversion of the analytes to charged ions must occur.

In some mass spectrometric systems, an ion guide can receive ions from an upstream ion source and can focus the ions into an ion beam for transmission to downstream ion optics. In some mass spectrometers, such an ion guide allows a continuous transmission of all ions received by the ion guide into the downstream ion optics. In some other mass spectrometers, the ion guide can include a set of electrodes, e.g., in the form of T-bars, that can be utilized to create a controllable high-mass cut-off within the ion guide, which can prevent unwanted high mass ions from being transmitted into downstream ion optics, thereby preventing contamination of those components. For example, in mass spectrometers operating in a multiple reaction monitoring (MRM) mode, the ions passing through the ion guide are received by a downstream ion mass filter that can select precursor ions having target m/z ratios for fragmentation to generate daughter ions for MRM analysis. In such mass spectrometers, the voltages applied to such T-bar electrodes can be set to create a high mass cut off (HMCO) higher than the precursor mass under current analysis and a calibration table can be used to correlate the T-bar voltages with the precursor mass. The ions filtered during one MRM detection cycle need to be reintroduced into the ion guide for analysis in a subsequent MRM cycle.

The ion transit time through the ion guide can influence the refilling of the ion guide with ions previously filtered and hence the duty cycle of the mass measurements. Ion transit time through the ion guide is affected by space charge as well as m/z ratios of the ions, ion beam intensity, and the pressure within the ion guide. Generally, ion transit time is shorter for ions having lower m/z ratios and higher charge states. The ion transit time can also vary with space charge. Further, an elevated pressure in the ion guide can slow down ion transmission through the ion guide.

By way of example, in some cases, the ion transit time can be in a range of about 0.1 ms to about 30 ms, e.g., in a range of about 1 ms to 20 ms or in a range of about 5 ms to about 10 ms. Further, in fast MRM measurements, the transit time of ions in the ion guide may need to be shorter than about 5 ms. Under such circumstances, ions may not have sufficient time to refill the ion guide during the pause time between successive MRM dwell times. For some workflows it is desirable to maximize the total number of MRM transitions monitored by reducing the analytical measurement time (dwell time) and the optics refill time between measurements (pause time).

### SUMMARY

In one aspect, a method for transmitting ions through an ion guide in a mass spectrometer is disclosed, which includes using a plurality of rods arranged in a multipole configuration and each extending continuously from the proximity of an inlet of an ion guide to the proximity of an outlet of the ion guide to generate a radial confining electromagnetic field for radially confining ions received via the inlet of the ion guide into a space between said rods, using a plurality of auxiliary electrodes positioned between the multipole rods to generate an electric field in at least one region of the ion guide for reducing radial confinement of a first subset of the received ions in said at least one region to inhibit passage thereof to a downstream region of the ion guide while allowing a second subset of the ions to reach the downstream region of the ion guide, and axially accelerating said second subset of the ions in said downstream region of the ion guide to expedite exit of said second subset of the ions from the ion guide.

The step of using the multipole rods to generate the radial confining electromagnetic field can include applying one or more RF voltages to the multipole rods. Further, the step of using the plurality of auxiliary electrodes to generate the electric field can include applying a DC bias voltage to at least one of the auxiliary electrodes to generate a DC electric field. By way of example, the DC bias voltage can be in a range of about −1000 volts to about +1000 volts. In some situations, the DC bias voltage can be split across the 2 poles rather than applied to just one of the poles.

The DC electric field is generated along a direction that is substantially orthogonal to a longitudinal axis of the ion guide.

The step of axially accelerating the second subset of the ions includes applying a DC offset voltage between a set of ion accelerating electrodes positioned in the downstream region of the ion guide and the multipole rods. By way of example, in some embodiments, such a DC offset voltage can be in a range of about −1000 volts to about +1000 volts e.g., in a range of about −500 volts to about +500 volts, or in a range of about −100 volts to about −150 volts.

In some embodiments, the multipole configuration can be any of a quadrupole, a hexapole and an octupole configuration. In other embodiments, the multipole configuration can include any number of rods.

In a related aspect, an ion guide for use in a mass spectrometer is disclosed, which includes an inlet for receiving ions and an outlet through which ions can exit the ion guide. The ion guide can further include a plurality of rods arranged in a multipole configuration and extending continuously from proximity of ion guide's inlet to proximity of said outlet and configured for application of RF voltages thereto to generate a radial confining electromagnetic field within a space between the rods. The ions entering the ion guide via its inlet pass through a first region in which the ions are only subjected to the radially confining electromagnetic field generated by the voltages applied to the multipole rods.

A plurality of auxiliary electrodes is positioned between the rods and is configured for application of at least one DC voltage thereto for generating an electric field within a second region of the ion guide, positioned downstream from the first region, for reducing radial confinement of a first subset of ions in that second region to inhibit their passage to a downstream region of the ion guide (herein also referred to as the third region) while allowing a second subset of ions to reach the third region. Further, a set of additional electrodes (herein also referred to as ion accelerating electrodes) is positioned in the ion guide for generating an axial accelerating electric field in the downstream third region of the ion guide for accelerating the second subset of ions so as to expedite their exit from the ion guide via said outlet thereof. Because the ion guide rods are continuous, a radially confining field is present in the third region, similar to the first region. In the second region, the application of DC voltages to the T-bar electrodes can result in the weakening of the radial confining field for a subset of the ions.

In some embodiments, these additional electrodes may be arranged in any suitable configuration that can provide the requisite axial electric field for accelerating the ions. One example of such a configuration is herein referred to as a LINAC™, though any suitable configuration that would provide an axial electric field for accelerating the ions within the third region can be utilized. By way of further illustration, in the first region in the immediate vicinity of the ion guide's inlet, the ions received by the ion guide are subjected only to the radially confining RF field generated by RF voltage(s) applied to the rods. As ions enter the second downstream region in which the auxiliary electrodes are positioned, the ions are subjected to both the RF field generated by the RF voltage(s) applied to the rods as well as the DC field generated by the DC voltage(s) applied to the auxiliary electrodes, which results in the weakening of the radial confining field for a subset of the ions, thus inhibiting those ions from reaching the third region of the ion guide in which the accelerating electrodes are positioned. The subset of the ions reaching the third region are accelerated via an axial electric field generated by the accelerating electrodes to expedite their transit through the ion guide, while also being subjected to the radially confining RF field.

In this embodiment, the auxiliary electrodes can have a T-shaped configuration characterized by a stem extending from a base toward the space between the plurality of rods.

The ion guide can further include an RF voltage source for generating RF voltages for application to the plurality of multipole rods and a DC voltage source for generating DC voltages for application to any of the auxiliary and the ion accelerating electrodes. In some embodiments, the DC voltage source is configured to apply a DC voltage to at least one of the ion accelerating electrodes so as to generate a DC offset voltage in a range of about −2000 volts to about +2000 volts between the ion accelerating electrodes and the multipole rods. Further, by way of example, the RF voltage(s) applied to the multipole rods can have a frequency in a range of about 0.1 MHZ to about 5 MHz.

An ion mass filter can be positioned downstream of the ion guide for receiving the ions exiting the ion guide.

In a related aspect, a method for transmitting ions through an ion guide in a mass spectrometer is disclosed, which includes a plurality of rods arranged in a multipole configuration and configured for application of RF voltages thereto for generating a radial confining electromagnetic field within a space between the rods, where the rods are shaped and sized such that said radial confining electromagnetic field extends from proximity of an inlet of the ion guide through which ions can enter the ion guide to an outlet of the ion guide through which ions can exit the ion guide. A plurality of auxiliary electrodes is positioned between the rods and configured for application of at least one DC voltage thereto for generating an electric field within a region of the ion guide for reducing radial confinement of a first subset of ions in that region in order to inhibit their passage to a downstream region of the ion guide while allowing a second subset of ions to reach the second downstream region, and a set of ion accelerating electrodes (such as LINAC™ electrodes) positioned in said ion guide for generating an axial accelerating electric field in the downstream region so as to expedite the exit of the second subset of ions from the ion guide via said outlet thereof.

Further understanding of various aspects of the present teachings can be obtained by reference to the following detailed description in conjunction with the associated drawings, which are described briefly below.

### BRIEF DESCRIPTION OF THE DRAWINGS

FIG. 1A schematically depicts an ion guide according to an embodiment of the present teachings,

FIG. 1B schematically depicts an end view of the ion guide depicted in FIG. 1A,

FIG. 1C is a schematic perspective view of the ion guide depicted in FIG. 1A,

FIG. 1D is a schematic perspective view of an ion accelerating electrode, illustrating its tapered shape,

FIG. 2 show examples of ion transit times through a Q0 ion guide of a prototype mass spectrometer for an ion having an m/z of 922,

FIG. 3 shows an offset potential for Q0 versus the ion path as a result of the LINAC voltage(s) in an ion guide according to an embodiment having quadrupole rods, T-bars and LINAC™ electrodes similar to those shown in the ion guide depicted in FIG. 1A as a function of a DC offset voltage between the LINAC™ electrodes and the quadrupole rods,

FIG. 4 shows comparisons of transit time for an ion having an m/z of 829.5 through an exemplary ion guide according to the present teachings under various LINAC™ voltages and T-bar conditions,

FIG. 5 shows data indicating an ion signal loss can be recovered via application of accelerating voltages to accelerate ions on a TOF mass spectrometric system with the application of T-bar bandpass, and

FIG. 6 shows data indicating an ion signal loss can be recovered via application of accelerating voltages to accelerate ions on a triple quadrupole mass spectrometric system with the application of T-bar bandpass.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein mean 10% greater or less than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

As noted above, the ion transit time through an ion guide of a mass spectrometer positioned upstream of an ion filter, during Multiple Reaction Monitoring (MRM) mass analysis, with ions that were previously filtered can influence the refilling of the ion guide and hence the duty cycle of the mass measurements. Ion transit time through the ion guide is affected by space charge as well as m/z ratios of the ions, ion beam intensity, and the pressure within the ion guide. Generally, ion transit time is shorter for ions having lower m/z ratios and higher charge states. The ion transit time can also vary with space charge and is typically longer for lower TIC. Further, an elevated pressure in the ion guide can slow down ion transmission through the ion guide.

By way of example, in some cases, the ion transit time can be in a range of less than 0.1 ms to about 30 ms, e.g., in a range of about 1 ms to about 20 ms or in a range of about 5 ms to about 10 ms. When running fast MRM experiments, it is desirable to minimize the duty cycle for a measurement, including both the pause time for setting potentials and the dwell time for acquiring data. Under such circumstances, ions may not have sufficient time to refill the ion guide during each MRM cycle when conventional techniques are utilized for ion filtering.

In mass spectrometers utilizing ion guides (herein referred to for ease of description as Q0 or Q0 ion guide) for focusing ions generated by an upstream ion source for delivery to a downstream ion mass filter (herein referred to for ease of description as Q1 or Q1 mass filter), auxiliary electrodes can be utilized, e.g., in the form of T-shaped electrodes (herein also referred to as T-bars), to create a controllable high-mass cut-off (HMCO) that can prevent unwanted high mass ions from being transmitted into downstream ion optics, which could otherwise lead to contamination of those ion optics. In other words, while conventional ion guides can allow all ions received from an upstream ion optic to continuously pass through, T-bars incorporated in such ion guides can be used to create HMCO windows that allow only those ions having m/z ratios less than the cut-off to pass through the ion guide. For example, voltages applied to the T-bars can create a HMCO in Q0 that is above the largest m/z ratio to be selected by Q1 for multiple reaction monitoring (MRM) analysis and a calibration table can be used to correlate the T-bar voltages with the ion mass. More particularly, in embodiments, the combination of the HMCO provided by the T-bar electrodes and a LMCO provided by the RF voltage amplitude applied to the set of multipole rods generates a bandpass window. By way of example, T-bar electrodes disclosed in U.S. Pat. No. 10,741,378 and U.S. Published Patent Application No. US20210327700, each of which is herein incorporated by reference in its entirety, can be employed in the practice of the present teachings.

When analyzing multiple compounds by MRM, it is necessary to switch conditions between MRM analysis for each of those compounds. If the bandpass window excludes the other m/z ratio(s), ions will be eliminated from the ion guide. Therefore, it will be necessary to refill the Q0 optics to pass ions having the next m/z ratio to the mass analyzer prior to acquiring the next MRM transition. Thus, the ion transit time in Q0 is a parameter that can affect the duty cycle of the MRM mass spectrometry. Under normal operation, a “dwell” time or “acquisition” time can be defined during which the signal for a first compound or range of compounds is measured. Prior to the next dwell time, the method includes a “pause” time to allow for setting potentials and refilling the front-end ion optics. If the transit time is very short, the pause time can be minimized, leading to increased analytical measurements, or dwell times.

Ion transit time is affected by space charge as well as m/z of ions, ion beam intensity, and Q0 pressure levels. In fast MRM analysis of a compound, the dwell time (i.e., the time required for monitoring a particular MRM transition) can be shorter than 5 ms. Under such circumstances, ions may not have sufficient time to refill Q0 during each MRM using conventional T-bar filtering. In some techniques, this problem is addressed by employing a “single” high mass cut-off to ensure that all ions for which analysis is desired are consistently transmitted through multiple bandpass windows by adjusting the window sizes based on Q1 precursor m/z. The HMCO can be determined by the highest m/z in the ion list. This method uses a relatively large window to provide sufficient time for refilling Q0, but it may limit the protection of the downstream optics from contamination. By way of example, assuming that MRM analysis of a group of ions is desired, where most of the ions have m/z ratios in a range of 400-1000 with a few ions having m/z ratio of 1500, the HMCO of Q0 can be set, for example, at m/z of 1600 or higher. In such a case, the HMCO offset would be 1200 Da for m/z 400 and 600 Da for m/z 1000. For lower m/z ratios, the T-bar voltages would be close to zero for creating large window sizes. Further, the optimal RF voltages applied to the ion guide for the highest m/z ion may be sufficient to filter out low m/z ions.

Accordingly, approaches for reducing ion transit time are needed for solving the problem of insufficient time for refilling ion guides providing filtering of ions prior to their arrival at a downstream mass filter, e.g., when operating a mass spectrometer in any scan mode, that is accessible on any mass spectrometer analyzer, including but not limited to quadrupoles, triple quadrupoles, ion traps, and time of flight instruments.

As discussed in more detail below, in embodiments, the present teachings provide filtering of ions in a first region of an ion guide and utilize an axial electric field in a second region, which is positioned downstream of the first region, to receive unfiltered ions, so as to accelerate the unfiltered ions and hence expedite their transit through the ion guide. As discussed in more detail below, in the following embodiments, a set of LINAC™ electrodes are employed to create a voltage drop on the propagation axis of the ion guide. By way of example, and without limitation, voltages in a range of about −2000 volts to about +2000 volts can be applied to the LINAC™ electrodes to create an axial potential drop. By way of example, and without limitation, in some embodiments, an axial potential drop in a range of about 0.9 V to about 1.3 V can be achieved via application of voltages in a range of about −100 volts to about −150 volts to the LINAC™ electrodes. Such a voltage drop should be added to a potential difference that would be normally present between the Q0 rods and the rest of the ion path downstream of the Q0 rods in order to maintain similar potential differences in the absence of LINAC™ voltages. In some embodiments, rather than reducing the potentials on the ion path downstream of Q0, the Q0 offset voltage can be increased to maintain a desired potential difference when Q0-LINAC™ offset voltage is applied. In general, the change in Q0 offset voltages can vary based on the LINAC™ voltages and the Q0 offset voltages are preferably configured to maintain ion transmission such that comparable ion transmissions can be achieved with and without LINAC acceleration voltages applied. For example, in some embodiments in which ions under mass analysis have positive polarity, the Q0 offset voltage can be generated by maintaining the multipole rods at a more positive voltage relative to the voltage applied to the accelerating electrodes. In some embodiments in which ions under mass analysis have a negative polarity, the Q0 offset voltage can be generated by maintaining the multipole rods at a less positive voltage relative to the voltage applied to the accelerating electrodes. For brevity, and without limitation, such relative voltages of the multipole rods relative to the accelerating electrodes is herein referred to being achieved by maintaining the multipole rods at a higher DC potential relative to the accelerating electrodes.

U.S. Pat. Nos. 5,847,386 and 6,111,250, which are herein incorporated by reference in their entirety provide additional information regarding auxiliary LINAC™ electrodes that can be utilized in accordance with the present teachings to create an acceleration field along the propagation axis of ions.

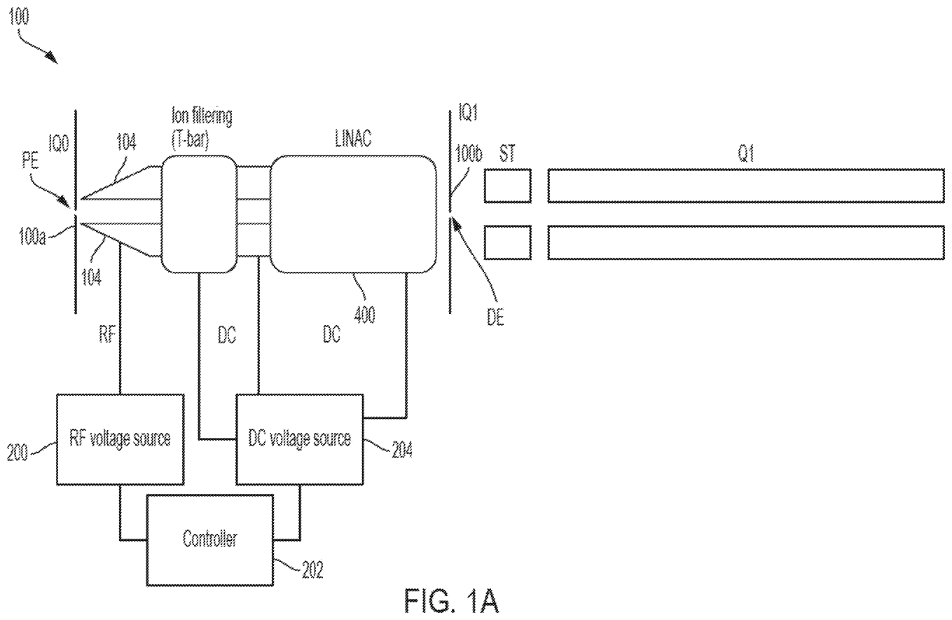

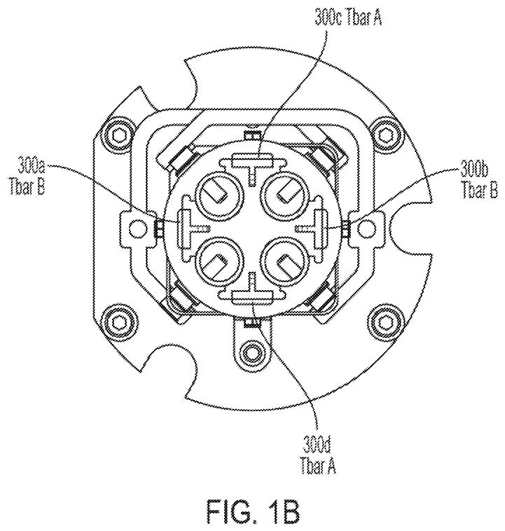

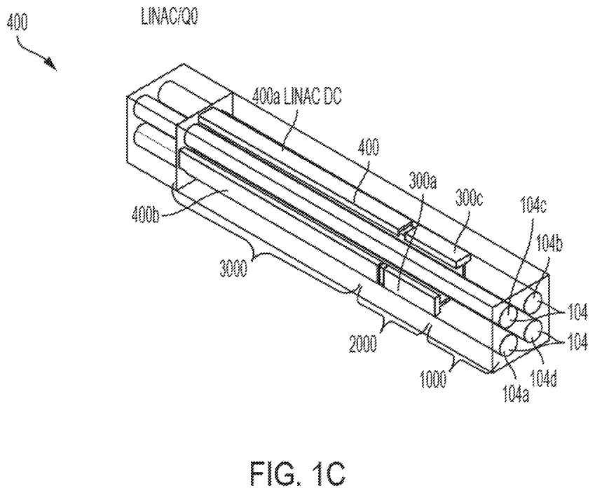

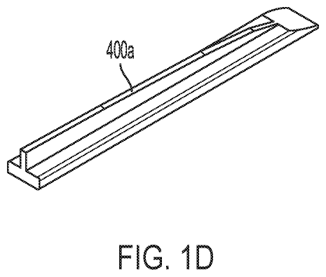

With reference to FIGS. 1A, 1B, 1C, and 1D, an ion guide 100 according to an embodiment of the present teachings includes an inlet 100a for receiving ions generated by an upstream ion source (not shown) and an outlet 100b through which ions can exit the ion guide.

The ion guide 100 includes a set of rods 104, which are arranged according to a multipole configuration and are spaced apart to provide an ion passageway through which ions can travel. In this embodiment, the rod set 104 includes four rods 104a, 104b, 104c and 104d that are arranged according to a quadrupole configuration. In this embodiment, each of the rods 104 extends, as a continuous element, from a proximal end (e.g., proximal end depicted as PE with respect to rod 104a) to a distal end (e.g., a distal end depicted as DE with respect to the rod 104a). The proximal ends of the quadrupole rods are positioned at or in proximity of the inlet 100a of the ion guide and the distal ends of the quadrupole rods are positioned at or in proximity of the outlet 100b of the ion guide. For example, the distance between the proximal end of the rods 104 and the inlet of the ion guide chamber, which is defined herein as the orifice of a lens IQ0 positioned at the entrance of the ion guide, can be, for example, in a range of about 0.5 mm to about 6 mm, e.g., in a range of about 1 mm to about 5 mm or in a range of about 2 mm to about 4 mm. Similarly, the distance between the distal end of the rods 104 and the outlet of the ion guide, which is defined herein as the orifice of a lens IQ1 positioned at the outlet of the ion guide chamber, can be, for example, in a range of about 0.5 mm to about 6 mm, e.g., in a range of about 1 mm to about 5 mm or in a range of about 2 mm to about 4 mm. Thus, the rods of the quadrupole rod set extend continuously from the inlet (or from a point in proximity to the inlet of the ion guide chamber) of the ion guide to the outlet (or to a point in proximity of the outlet) of the ion guide chamber, ensuring radial focusing of at least a portion of the ions along the entire length of the ion guide. In other words, the rods of the quadruple rod set are not in the form of a plurality of segments positioned relative to one another with gaps separating adjacent segments from one another, where continuous radial focusing of the ions from the inlet to the outlet of the ion guide would not be feasible.

An RF voltage source 200 operating under control of a controller 202 applies RF voltages to the rods of the quadrupole rod set to generate an electromagnetic field within the ion passageway for providing a radial confinement of the ions as they travel through the ion guide.

The quadrupole rods can be characterized as comprising a plurality of pairwise poles where the RF voltages applied to the rods of each pole are substantially equal (the rods of each pole are equipotential) while the phase of the voltages applied to one pole is the opposite of the phase of the voltages applied to the other pole.

The RF voltages applied to the quadrupole rods can generate a quadrupolar electromagnetic field within the ion passageway that can facilitate the radial confinement of the ions.

In some embodiments, the RF voltages applied to the multipole rods can have a frequency in a range of about 0.1 MHz to about 5 MHz, e.g., in a range of about 1 MHz to about 3 MHz, or in a range of about 3 MHz to about 5 MHz In some such embodiments, the RF voltages can have an amplitude in a range of about 10 volts to about 5 kilovolts (V₀₋ₚ), e.g., in a range of about 100 to 2000 V₀₋ₚ.

A DC voltage source 204, also operating under control of the controller 202, can apply offset DC voltages to the quadrupole rods so as to provide an offset DC voltage between the quadrupole rods and an upstream and/or a downstream ion optic (e.g., a downstream ion mass filter).

With continued reference to FIGS. 1A, 1B, 1C, and 1D, a plurality of auxiliary electrodes 300a, 300b, 300c, and 300d, which are herein collectively referred to as the T-shaped auxiliary electrodes or T-shaped electrodes or T-bars 300), is interspersed between the quadrupole rod set such that each auxiliary electrode is interposed between two of the quadrupole rods. In this embodiment, the auxiliary electrodes have a T-shaped configuration characterized by a base that extends parallel to the quadrupole rods and a stem that extends orthogonally from the base toward the ion passageway. In this embodiment, the auxiliary electrodes 300 can be grouped into two pairs, which are herein referred to as T-bar A and T-bar B.

The pair of the auxiliary electrodes 300a/300b forms one pole of the auxiliary electrodes (herein referred to as the B-pole) and the pair 300c/300d (herein referred to as the A-pole) forms the other pole of the auxiliary electrodes.

In this embodiment, the auxiliary electrodes 300 do not extend across the entire length of the ion guide. In other words, the length of the base of the T-shaped electrodes is less than the longitudinal length of the ion guide. The auxiliary electrodes 300 may be positioned in a region of the ion guide that is closer to the ion guide's inlet than its outlet.

As noted above, the ions entering the ion guide pass through the first region 1000 of the ion guide are subjected only to the radial confining field generated by the voltage(s) applied to the multipole rods. The DC voltage source can apply DC voltages to the T-shaped auxiliary electrodes such that the DC potential difference between the auxiliary electrodes (as well as the potential difference between the auxiliary electrodes and the quadrupole rods) can generate a DC field (e.g., an octupolar DC field distribution) within the second region 2000 of the ion passageway that can cause a reduction in ion confinement experienced by a subset of ions (herein also referred to as the first subset) having m/z ratios within a target range that are received by the ion guide, thereby inhibiting the passage of those ions through the ion guide, while allowing other ions received by the ion guide to continue propagating through the ion passageway. For example, the reduction in the ion confinement of the first subset of ions can result in those ions following trajectories that result in the ions being attracted to the auxiliary electrodes and striking those electrodes, thereby being removed from the set of ions propagating toward the outlet of the ion guide. The T-bar electrodes can be used to establish a high mass cut off (HMCO) and the RF voltage applied to the multipole rods can be used to establish a low mass cut off (LMCO) such that the combination of the HMCO and the LMCO provides a bandpass filter that allows transmission of ions with m/z ratios within an m/z range while inhibiting the passage of ions with m/z ratios outside of that m/z range.

By way of example, the DC bias voltage applied to the T-shaped auxiliary electrodes can be in a range of about −1000 volts to about +1000 volts. In some embodiments, the DC bias voltage can be split across both poles of the T-bars with the Q0 DC offset as the zero (reference) point. The remaining ions (herein referred to as a second subset of ions) continue to propagate along the ion guide. The voltages applied to the T-shaped auxiliary electrodes can establish a HMCO that in combination with the LMCO established by the RF voltages applied to the multipole rods generates a bandpass filter that inhibits the passage of one subset of ions but allows the passage of another subset.

With particular reference to FIGS. 1A and 1C, in this embodiment, a set of LINAC™ (linear accelerator) electrodes 400 are positioned downstream of the T-shaped electrodes. In this embodiment, the set of LINAC™ electrodes includes four electrodes (two of which 400a/400b are visible in FIG. 1C) each of which is interposed between two of the quadrupole rods. As shown in FIG. 1D, in this embodiment, each of the LINAC™ electrodes has a tapered profile such that the application of DC voltages to those electrodes results in generation of an axial electric field within the third region 3000 of the ion guide, which is positioned downstream of the second region 2000 and corresponds substantially to a portion of the ion passageway that is surrounded by the LINAC™ electrodes, to axially accelerate the ions that pass through bandpass filter toward the outlet of the ion guide.

By way of example, and without limitation, the DC voltages applied to the T-shaped electrodes can be in a range of about −1000 volts to about +1000 volts.

In embodiments, the generation of an axial electric field in the region 3000 of the ion guide can reduce the transit time of ions passing through the ion guide by a factor in a range of about 2X to about 30X. For example, in embodiments, due to the use of the axial accelerating field, the passage time of ions through the ion guide can be, for example, equal to or less than about 5 ms, e.g., in a range of about 1 ms to about 5 ms. This can in turn allow rapid refilling of the ion guide. In this manner, a bandpass filter provided by the combination of the multipole rods and the T-shaped electrodes can significantly reduce the contamination of the downstream ion optics while the axial electric field provided by the LINAC™ electrodes allows rapid filling of the ion guide with those ions removed by the bandpass filter.

The following Examples are provided for further elucidation of various aspects of the present teachings and are not provided to indicate necessarily optimal ways of practicing the present teachings and/or optimal results that may be achieved.

### EXAMPLES

### Example 1

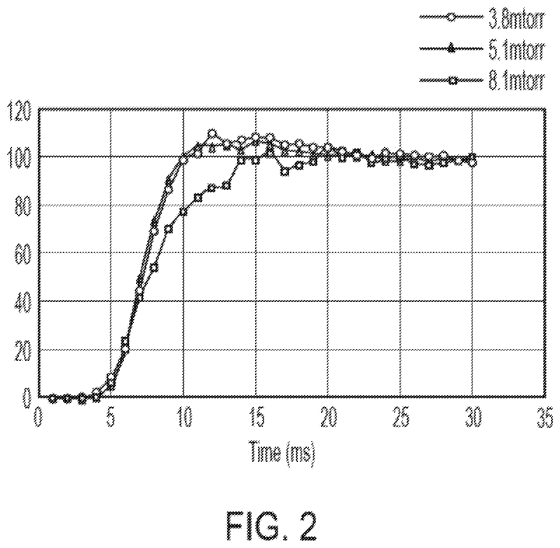

FIG. 2 shows examples of ion transmit times through a Q0 ion guide of a prototype mass spectrometer for an ion having an m/z of 922. T-bar electrodes were integrated in the Q0 ion guide to create a controllable high-mass cut off (HMCO), which can prevent unwanted ions from being transmitting into downstream ion optics to reduce and preferably eliminate contamination of the downstream ion optics by such ions.

The data presented in FIG. 2 was acquired on a system that did not include LINAC™ electrodes, such as those discussed above, and included a 12 cm Q0 ion guide. As the pressure of the Q0 region increased, longer time frames were required to refill the ion optics.

To obtain the data depicted in FIG. 2, T-bar voltages were set to create a HMCO higher than the m/z ratio of the precursor ion selected by a downstream mass filter (Q1) by about 100 Da. A calibration table was built to correlate the T-bar voltages with the Q1 mass filter (i.e., with the m/z ratio of ions passing through the Q1 mass filter).

The above data shows that the ions required at least about 5-10 ms to transit through the Q0 region when using a 12 cm Q0 with various pressures. The transit time can be further slowed down to 10-30 ms when using a longer Q0 assembly, such as a Q0 assembly having a length in the range of 15-18 cm. For example, in the data depicted in FIG. 2, as the pressure within Q0 increases, the time required to refill the Q0 ion guide also increases.

### Example 2

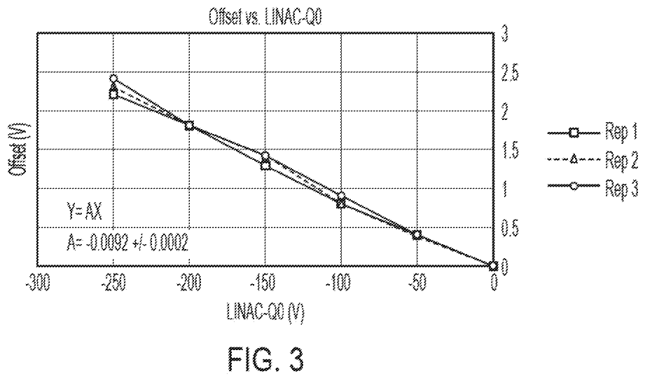

FIG. 3 shows an offset potential for Q0 versus the ion path as a result of the LINAC™ voltage in an ion guide according to an embodiment having quadrupole rods, T-bars and LINAC™ electrodes similar to those depicted in FIG. 1A as a function of a DC offset voltage applied between the LINAC™ electrodes and the quadrupole rods The potential drop ranged from about 0.9 V to about 1.3 V as the offset voltage between the LINAC™ electrodes and the Q0 ranged from about −100 volts to about −150 volts.

The offset voltage between the LINAC™ electrodes and the Q0 rods should be added to a potential difference that would be normally present between the Q0 and the rest of the ion path downstream of the Q0 in order to maintain the requisite potential differences in absence of the QO LINAC electrodes. In some cases, rather than dropping the voltages on the ion path downstream of Q0, the Q0 offset voltages are increased to maintain the desired potential difference when Q0-LINAC™ offset voltage is applied. This allows achieving comparable ion transmission with and without LINAC acceleration.

### Example 3

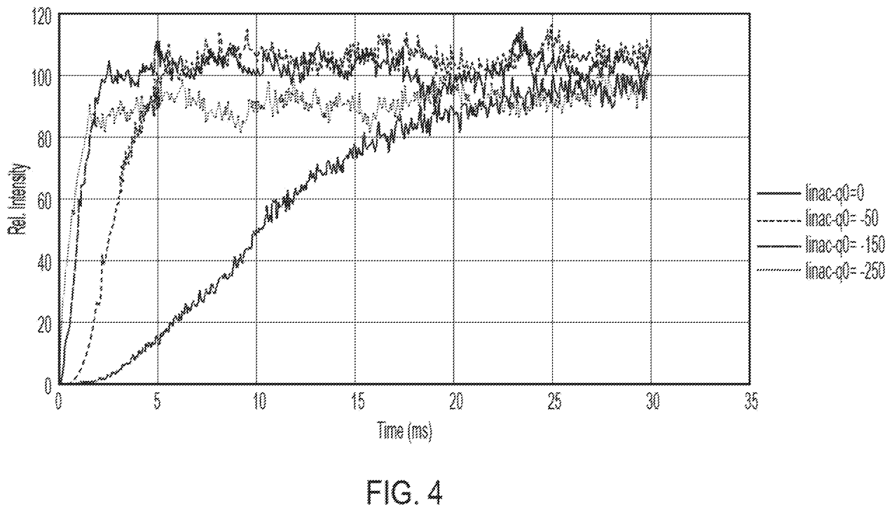

FIG. 4 shows comparisons of transit time for an ion having an m/z of 829.5 through an exemplary ion guide according to the present teachings under various LINAC™ voltages with T-bars enabled and a 15 cm Q0. The transit times were measured by monitoring the total ion current using a Time of Flight (ToF) instrument. The data shows that the required refill time is about 20-25 ms without the use of the LINAC™ electrodes for accelerating the ions and is less than about 5 ms with LINAC™ voltages of −50 and −250 applied between the LINAC™ electrodes and the Q0rods. Similar improvements have also been measured on triple quadrupole systems.

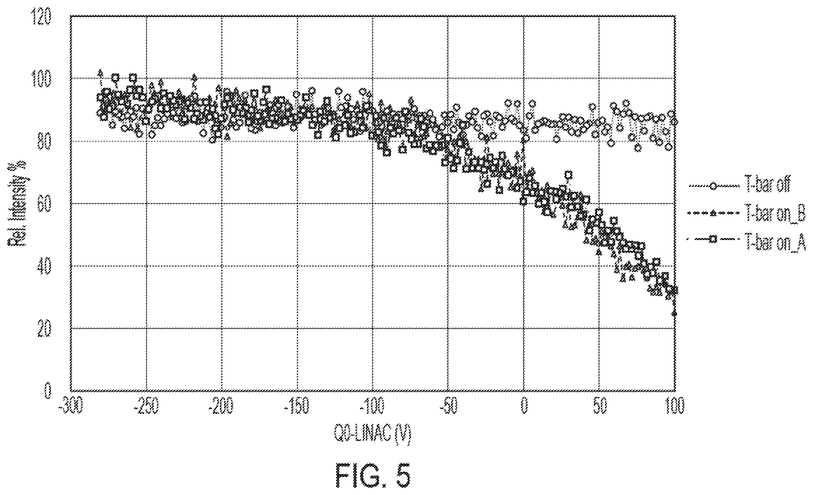

By way of further illustration, FIG. 5 shows data indicative of the relative intensity of ions passing through the ion guide as a function of the offset voltage between the Q0 multipole rods and the LINAC™ electrodes, for the following three cases: (1) T-bar off (T-bar bandpass disabled), ), (2) T-bar on B (T-bar bandpass enabled with filtered ions deposited onto T-bar B pole), (3) T-bar on A (T-bar bandpass enabled with filtered ions deposited onto T-bar A pole). Signals of a relatively low-m/z (829.5) compound and a high-m/z (1446.7) compound were measured using a TOF/MS/MS spectrometer in which a 15 cm Q0 ion guide according to the present teachings was incorporated with 10 ms accumulation measurement time and 2 ms pause time. FIG. 5 shows the comparison of signals of the high m/z ions (m/z 1446.7). With the T-bar bandpass disabled (T-bar off), there was a continuous flow of ions through Q0, and hence no difference in the transmission of m/z 1446.7 was observed as the LINAC voltage was ramped up.

The application of DC bias voltages to the T-bar electrodes to create a HMCO at m/z 929.5 during first TOFMSMS of m/z 829.5 resulted in the ions of m/z 1446.7 being out of the transmission window while ions with m/z 829.5 passed through Q0. Thus, the ions with m/z 1446.7 must be refilled into Q0 when the T-bar bandpass is changed to allow transmission of ions with m/z of 1446.7 through Q0. The ions could be quickly refilled into the Q0 when LINAC voltages in a range of −100 V to −300 V were employed. In contrast, with Q0-LINAC voltage set to zero, a 30%-40% signal loss was observed for m/z 1446.7, which indicates that the Q0 was not sufficiently refilled with the ions under this 12 ms time scale (10 ms measurement time +2 ms pause time).

### Example 4

In some embodiments, the application of LINAC™ offset voltages in a range of about −100 V to about −150 V can substantially reduce the fill time of the Q0 ion guide. The reduction in the fill time of the Q0 ion guide can be important, in particular when it is required to refill the Q0 quickly with ions with m/z ratios in the T-bars bandpass.

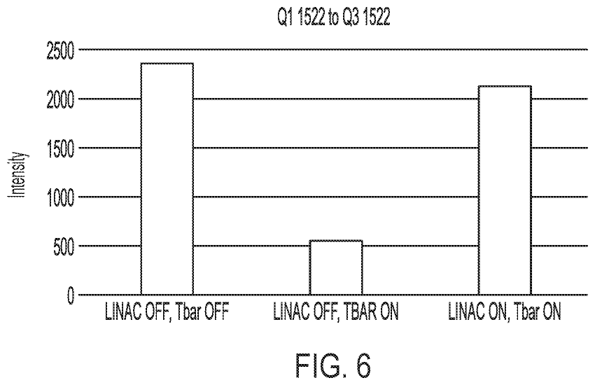

By way of further illustration, FIG. 6 shows data indicating that ion signal loss can be recovered via application of accelerating voltages to LINAC™ electrodes on a triple-quadrupole mass spectrometer system. The experiment included monitoring the signals for m/z 133 and m/z 1522 with the T-bar bandpass enabled. Data were collected using 2-ms dwell times and a 3-ms pause time. The baseline was acquired with the T-bar bandpass disabled (Tbar off, LINAC™ off), where there was a continuous flow of ions through Q0. The application of DC bias voltages to the T-bar electrodes to create a HMCO at m/z 233 during first MRM transition (m/z 133) resulted in the ions of m/z 1522 being out of the transmission window while ions with m/z 133 passed through Q0. Without LINAC™ acceleration (LINAC™ off, T-bar on), a 4X signal loss was observed for m/z 1522 due to the insufficient refill time. When an offset between LINAC electrodes and Q0 electrodes of −150 V was employed (LINAC™ on, T-bar on), the ions of m/z 1522 could be quickly refilled into the Q0, and the signal was restored.

The foregoing description of the embodiments has been presented for purposes of illustration only. It is not exhaustive and does not limit the embodiments to the precise form disclosed. While several exemplary embodiments and features are described, modifications, adaptations, and other implementations may be possible, without departing from the spirit and scope of the embodiments. For instance, the presented data was acquired using infusion but any mode of sample introduction may be used including LC. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature may exist in one or more embodiments.

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or. Moreover, if these terms are used, a subset of a set may include one or more than one, including all, members of the set.

Further, if used in this disclosure, and unless stated or deducted otherwise, a first variable is an increasing function of a second variable if the first variable does not decrease and instead generally increases when the second variable increases. On the other hand, a first variable is a decreasing function of a second variable if the first variable does not increase and instead generally decreases when the second variable increases. In some embodiment, a first variable may be an increasing or a decreasing function of a second variable if, respectively, the first variable is directly or inversely proportional to the second variable.

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise various steps may be omitted, repeated, combined, or performed in parallel, as necessary, to achieve the same or similar objectives. Similarly, the systems described need not necessarily include all parts described in the embodiments and may also include other parts not described in the embodiments. Accordingly, the embodiments are not limited to the above-described details, but instead are defined by the appended claims in light of their full scope of equivalents. Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

Those having ordinary skill in the art will appreciate that various changes can be made to the above embodiments without departing from the scope of the present teachings.

What is claimed is:

1. A method for transmitting ions through an ion guide in a mass spectrometer, comprising:
using a plurality of rods arranged in a multipole configuration and each extending continuously from proximity of an inlet of an ion guide to proximity of an outlet of the ion guide to generate a radial confining electromagnetic field for radially confining ions received via the inlet of the ion guide into a space between said rods,
using a plurality of auxiliary electrodes positioned between said rods to generate an electric field in a first region of the ion guide for reducing radial confinement of a first subset of the received ions in said first region to inhibit passage thereof to a downstream second region of the ion guide while allowing a second subset of the ions to reach the downstream second region of the ion guide, and
axially accelerating said second subset of the ions in said downstream second region of the ion guide to expedite exit of said second subset of the ions from the ion guide.

2. The method of claim 1, wherein said step of using the multipole rods to generate the radial confining electromagnetic field comprises applying one or more RF voltages to said plurality of the multipole rods.

3. The method of claim 1, wherein said step of using the plurality of auxiliary electrodes to generate the electric field comprises applying a DC bias voltage to at least one of said auxiliary electrodes to generate a DC electric field.

4. The method of claim 3, wherein said DC bias voltage is in a range of about −1000 volts to about +1000 volts.

5. The method of claim 3, wherein said DC electric field is generated along a direction substantially orthogonal to a longitudinal axis of said ion guide.

6. The method of claim 1, wherein the step of axially accelerating the second subset of the ions comprises applying a DC offset voltage between a set of ion accelerating electrodes positioned in the downstream second region of the ion guide and said multipole rods.

7. The method of claim 6, wherein said DC offset voltage is in a range of about −2000 volts to about +2000 volts.

8. The method of claim 1, wherein said multipole configuration comprises any of a quadrupole, a hexapole and an octupole configuration.

9. The method of claim 6, further comprising adjusting the DC offset voltage between said multipole rods and said ion accelerating electrodes to obtain a desired transmission rate of ions through the ion guide.

10. The method of claim 6, wherein said DC offset voltage is generated by maintaining said multipole rods at a higher DC potential relative to said accelerating electrodes.

11. An ion guide for use in a mass spectrometer, comprising:
an inlet for receiving ions and an outlet through which ions can exit the ion guide,
a plurality of rods arranged in a multipole configuration and extending continuously from proximity of said inlet to proximity of said outlet and configured for application of RF voltages thereto to generate a radial confining electromagnetic field within a space between the rods,
a plurality of auxiliary electrodes positioned between said rods and configured for application of at least one DC voltage thereto for generating an electric field within a first region of the ion guide for reducing radial confinement of a first subset of ions in said first region to inhibit their passage to a second downstream region of the ion guide while allowing a second subset of ions to reach said second downstream region, and
a set of ion accelerating electrodes positioned in said ion guide for generating an axial accelerating electric field in said second downstream region of the ion guide for accelerating said second subset of ions so as to expedite their exit from the ion guide via said outlet thereof.

12. The ion guide of claim 11, wherein said auxiliary electrodes have a T-shaped configuration characterized by a stem extending from a base toward the space between the plurality of rods.

13. The ion guide of claim 11, further comprising an RF voltage source for generating said RF voltages for application to said plurality of rods.

14. The ion guide of claim 13, further comprising a DC voltage source for generating DC voltages for application to any of said auxiliary and said LINAC electrodes.

15. The ion guide of claim 14, wherein said DC voltage source is configured to apply a DC voltage to said ion accelerating electrodes so as to generate a DC offset voltage in a range of about −2000 volts to about +2000 volts between the ion accelerating electrodes and said multipole rods.

16. The ion guide of claim 13, wherein said RF voltages have a frequency in a range of about 0.1 MHz to about 5 MHz.

17. The ion guide of claim 11, further comprising an ion mass filter positioned downstream of said ion guide for receiving the ions exiting the ion guide.

18. A method for transmitting ions through an ion guide in a mass spectrometer, comprising:
a plurality of rods arranged in a multipole configuration and configured for application of RF voltages thereto for generating a radial confining electromagnetic field within a space between the rods, wherein said rods are shaped and sized such that said radial confining electromagnetic field extends from proximity of an inlet of the ion guide through which ions can enter the ion guide to an outlet of the ion guide through which ions can exit the ion guide,
a plurality of auxiliary electrodes positioned between said rods and configured for application of at least one DC voltage thereto for generating an electric field within a first region of the ion guide for reducing radial confinement of a first subset of ions in said first region to inhibit their passage to a second downstream region of the ion guide while allowing a second subset of ions to reach said second downstream region, and
a set of ion accelerating electrodes positioned in said ion guide for generating an axial accelerating electric field in said second downstream region so as to expedite exit of the second subset of ions from the ion guide via said outlet thereof.
